(19) United States
(12) Patent Application Publication
(10) Pub. No.: US 2007/0073742 A1
(43) Pub. Date: Mar. 29, 2007

(54) MULTIPLE VIEWS FOR BREAKDOWN STRUCTURE CENTRIC PROCESS REPRESENTATIONS

(75) Inventors: J. Todd Fredrickson, Rockledge, FL (US); Peter Haumer, San Jose, CA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines, Armonk, NY (US)

(21) Appl. No.: 11/380,754

(22) Filed: Apr. 28, 2006

Related U.S. Application Data
(63) Continuation-in-part of application No. 11/238,550, filed on Sep. 29, 2005.

(51) Int. Cl. G06F 7/00; G06F 17/00

(52) U.S. Cl. 707/100

(57) ABSTRACT

Embodiments of the present invention address deficiencies of the art in respect to method and process management, and provide a data processing system, method, and computer program product for providing multiple views for breakdown centric process representations. In an embodiment of the invention, a data processing system configured for providing multiple views for breakdown centric process representations can be provided. The system can include a method management tool including program code enabled to render multiple views from a single breakdown structure architecture for a process. In particular, the multiple views can include at least two views selected from the group consisting of a task dependency view, a work product packaging dependency view and a relationship dependency view.

### CROSS-REFERENCE TO RELATED APPLICATIONS

This patent application claims the benefit under 35 U.S.C. § 120 as a continuation-in-part of presently pending U.S. patent application Ser. No. 11/238,550, entitled UNIFIED METHOD ARCHITECTURE, filed on Sep. 29, 2005, the entire teachings of which are incorporated herein by reference.

### BACKGROUND OF THE INVENTION

1. Field of the Invention

The present invention relates to the field of conceptual frameworks and tool support for the management of methods and processes, and more particularly to the systematic management of libraries of related method content and processes.

2. Description of the Related Art

A method architecture describes a schema for organizing large amounts of descriptions for development methods and processes, such as software engineering, mechanical engineering, business transformation, sales cycles and the like. A development method provides step-by-step explanations for a particular way of achieving a specific development goal under general circumstances such as transforming a requirements document into an analysis model, defining an architectural mechanism based on functional and non-functional requirements, creating a project plan for a development iteration, defining a quality assurance plan for functional requirements, or redesigning a business organization based on a new strategic direction.

A development process takes several of these methods and combines method steps into semi-ordered sequences creating a structure that is specific to temporal development circumstances such as how work is to be organized over time. The structure also can be specific to one type of development project, for instance the characteristics of the development project including development software for an online system versus software and hardware for an embedded system. A process is defined based on a lifecycle, which specifies how method elements such as tasks are being applied and work products are being produced over time by particular roles within the process.

Presently, there are several frameworks available in industry for the documentation of methods and the specification of processes. Commercial method and process management products include the Rational Unified Process Workbench manufactured by IBM Corporation of Armonk, N.Y., United States. International standards for schemas for method and process management systems also exist. The most widely know standard of this field is the Software Process Engineering Meta-Model (SPEM) version 1.1 released by the Object Management Group (OMG). These frameworks have been widely deployed for use in the enterprise. Yet, each has a different architecture and usage. Moreover, none are compatible with one another.

A development process can be viewed in multiple ways. Specifically, a development process can be viewed from the perspective of the work to be performed in the process, the items being worked upon, and the required skills to perform that work based upon roles. In conventional methods architecture, different arrangements of method content are required to support each view. As such, changes in the arrangement of method content in one view will not be reflected in other views. Consequently, the different views can fall out of synchronization.

### BRIEF SUMMARY OF THE INVENTION

Embodiments of the present invention address deficiencies of the art in respect to method and process management, and provide a novel and non-obvious data processing system, method, and computer program product for providing multiple views for breakdown centric process representations. In an embodiment of the invention, a data processing system configured for providing multiple views for breakdown centric process representations can be provided. The system can include a method management tool including program code enabled to render multiple views from a single breakdown structure architecture for a process. In particular, the multiple views can include at least two views selected from the group consisting of a work breakdown view, a work product usage view and a team allocation view.

The single breakdown structure architecture for the process can include an arrangement of descriptors mirroring default structural relationships of source method elements, for instance a task, a role or a work product. Each of the descriptors can be configured to permit changes to the arrangement between the descriptors without changing the default structured relationships of the source method elements. Activities as well as descriptors in the arrangement inherit the properties of general breakdown elements. In this regard, the single breakdown structure architecture for the process can include activities defined for the process wherein each of the activities is an aggregation of breakdown elements in a breakdown structure.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a methods management system configured for rendering multiple views for process breakdown structures in a method architecture;

FIG. 2 is a class diagram of a portion of a process breakdown structure architecture arranged to support a work breakdown view of a process;

FIG. 3 is a class diagram of a portion of a process breakdown structure architecture that relates to FIG. 2 arranged to support a work product usage view of a process;

FIG. 4 is a class diagram of a portion of a process breakdown structure architecture that relates to FIG. 2 arranged to support a team allocation view of a process;

FIG. 5 is a pictorial illustration of a process breakdown structure for rendering multiple views for breakdown structures in the method architecture of FIG. 1; and,

FIG. 6 is a class diagram of a descriptor separated unified method architecture incorporating breakdown structures.

### DETAILED DESCRIPTION OF THE INVENTION

Embodiments of the present invention provide a method, data processing system and computer program product for providing multiple views for breakdown centric process representations. As used herein, a breakdown structure is a representation for a development process. The architecture of the breakdown structure permits the assembly and presentation of different views of a process, whether from a work breakdown view, a work product usage view or a team allocation view. Consequently, changes in any of breakdown elements utilized in forming one view automatically can be reflected in the other views without requiring the coordinated maintenance of separate structures corresponding to the other views.

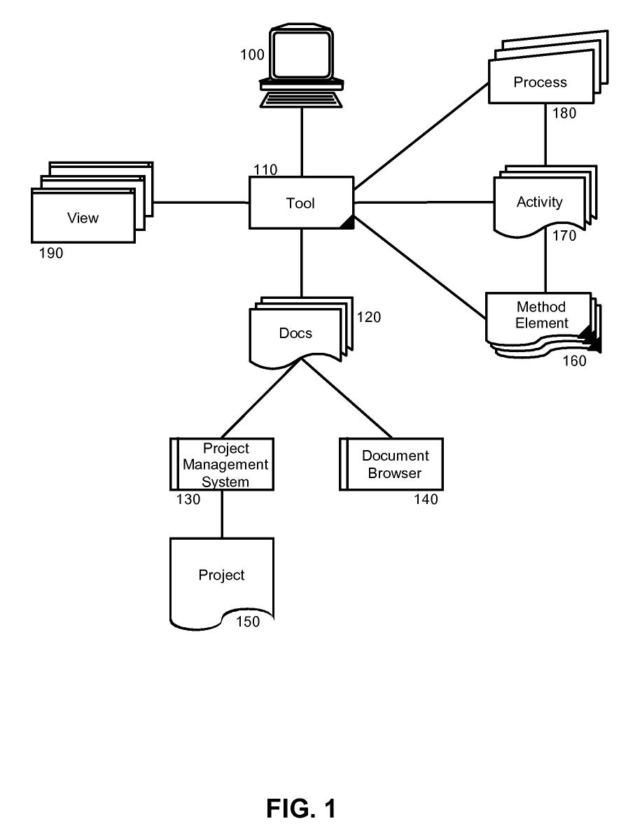

In more particular illustration, FIG. 1 is a schematic illustration of a methods management system configured for providing multiple views for breakdown centric process representations. Referring to FIG. 1, a computing platform 100 can host a methods management tool 110 configured to arrange method elements 160 into activities 170 using descriptors for one or more processes 180 in a model. The method elements 160 can define project methods and describe core element of methods in terms of roles, tasks, work products and guidance.

Generally, the method elements 160 can provide step-by-step explanations of how specific project goals can be achieved independently of the placement of the steps within a project lifecycle. As such, the methods management tool 110 can be configured to arrange the method elements 160 to produce one or more process documents 120. The process documents 120 can provide a description of a process and can be viewed within a document browser 140. Alternatively, the documents 120 can be provided as input to a project management system 130 to produce a project plan 150.

Importantly, a plurality of views 190 of a process 180 can be supported by the method elements 160 when arranged in the form of the specific breakdown structures proposed herein. The views can include a work breakdown view that shows how work is decomposed into sub-work in a process 180, the work product usage view that shows when which work products is being used and produced in a process 180, and the team allocation view that shows when specific performing roles and skills are required and have responsibilities in a process 180. Changes in the underlying breakdown structure defining the process 180 automatically will be reflected in the different views 190 without requiring coordinated modifications to separate data structures supporting each different view.

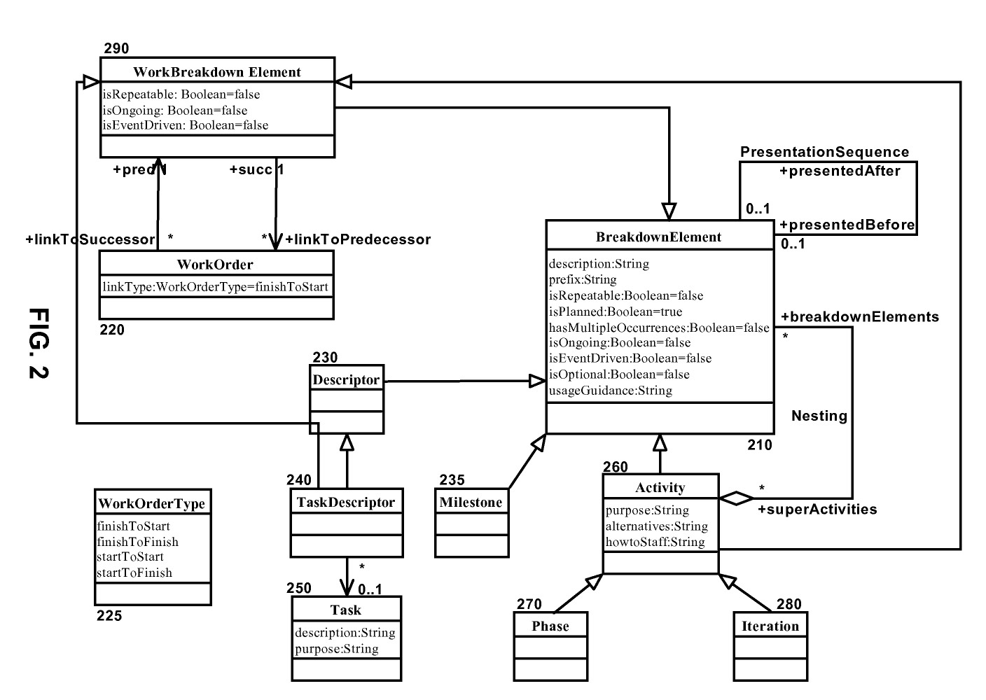

In further illustration, FIG. 2 is a class diagram of the method architecture providing multiple views for breakdown centric process representations. As shown in FIG. 2, a breakdown element 210 can form the core of the architecture enabling multiple different views of the same process. Each instance of the breakdown element 210 can reference other instances of the breakdown element 210 so as to form a sequence of breakdown elements as shown in FIG. 2. Activities 260 specialize breakdown elements further as do milestone 235, and phase 270 and iterations 260 yet further specialize the activity class 260. Notably, each instance of a breakdown element 210 can include an association with zero or more instances of an activity 260 in order to support a nested arrangement of activities and other breakdown elements in a process.

The breakdown element 210 can generalize a more specialized work breakdown element 290. The work breakdown element 290 can create and support linkages to both predecessor and successor instances of a work order 220 having a work order type 225 as shown in FIG. 2. The work order 220, itself can reflect a requested instance of a process that can include an arrangement of instances of an activity 260. The work breakdown element 290 also can generalize a task 250 via a task descriptor 240 which itself can generalize a descriptor 230.

A descriptor 230 can be characterized as a reference object for one particular method content element, which has its own relationships and properties. When an instance of a descriptor 230 is created it can be provided with congruent copies of the relationships defined for the referenced content element. However, these relationships can be modified for the particular process situation for which the instance of the descriptor 230 has been created. In this way, the use of a descriptor 230 allows each process to reference common method guidance from a common method content pool, which then makes up the actual process guidance. Because of these references, changes in the methods will automatically be reflected in all processes using descriptors 230.

In consequence of the process breakdown architecture shown in FIG. 2, a work breakdown view can be produced permitting the manipulation and sequencing of work. Additionally, the view can render the interdependencies (work order types) of those work breakdown elements. Ultimately, the breakdown structure based architecture of FIG. 2 can support the rendering of a project schedule used to manage the execution of work required to successfully complete a project based upon the delivery process described by the architecture. Notwithstanding, the process breakdown structure architecture can support other views as well.

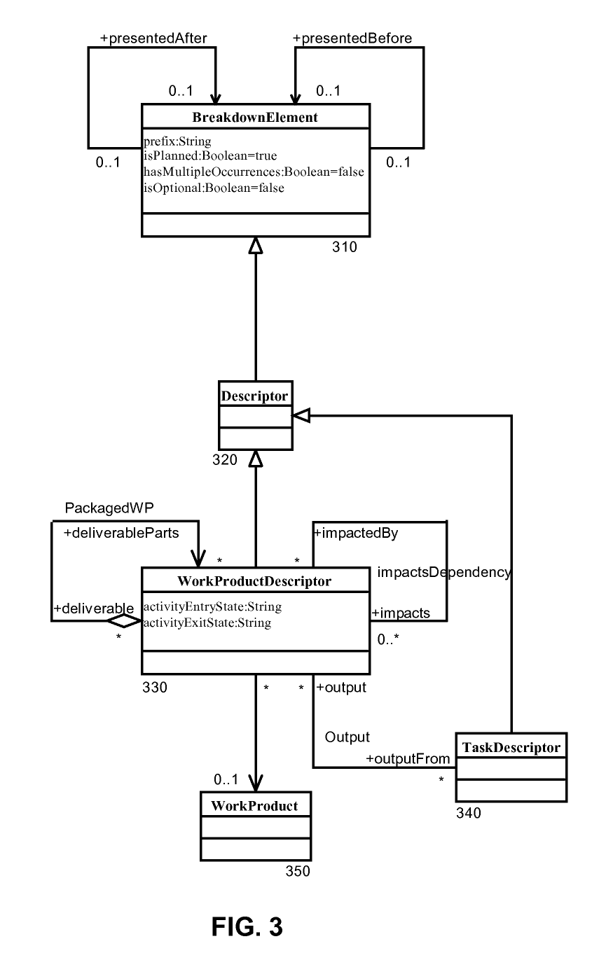

In particular, the process breakdown structure architecture further can support a work product usage view. In illustration, FIG. 3 is a class diagram of the process breakdown structure of FIG. 2 arranged to support a work product usage view of a process. As shown in FIG. 3, a work product descriptor 330 can be a specialization of a descriptor 320. Each work product descriptor 330 can create and encapsulate a reference to work product 350.

Each work product descriptor 330 further can create and encapsulate a reference to a work product 350 corresponding to other work product descriptors 330 viewed as deliverables in a process associated with an instance of a breakdown element 310. Work product 350 corresponding to an instance of a work product descriptor 330 can be viewed as the output from a task corresponding to instances of a task descriptor 340. The work product descriptor yet further can include references to additional instances of work product 350 corresponding to additional instances of a work product descriptor 330 so as to account for dependencies among work product. Utilizing a work product usage view supported by the data structure of FIG. 3, the dependencies of different work product can be viewed and validated in order to ensure the correctness and completeness of the overall process.

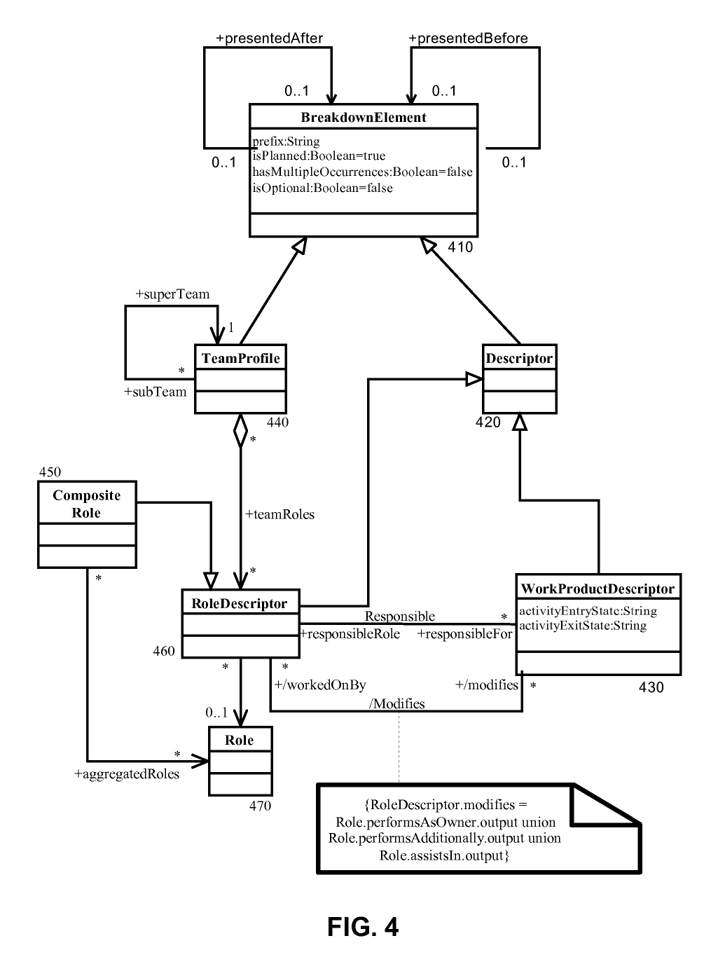

The process breakdown structure of the invention yet further can support a team allocation view of a process. In illustration, referring to FIG. 4, breakdown element 410 does generalize not only descriptors 420 in the general case, but also team profiles 440. The team profile 440 can create and encapsulate references to different team roles 470 separated by a role descriptor 460, as is the case with tasks and work product. The role descriptors 460 further can be aggregated into a composite role 450 as shown in FIG. 4.

Each role 470 referenced by a role descriptor 460 can include a reference to one or more instances of a work product descriptor 430. The references can represent a relationship between work product and role such as where a role is responsible for work product, or is under modification by a role. Consequently, while work product corresponding to a work product descriptor can be viewed in terms of output in a sequence of activities in a process, or in terms of dependencies on other work product, the work product further can be viewed in terms of a dependency relationship to roles in the process. Of course, any changes to an underlying role descriptor or work product descriptor automatically will be reflected in each of the different views.

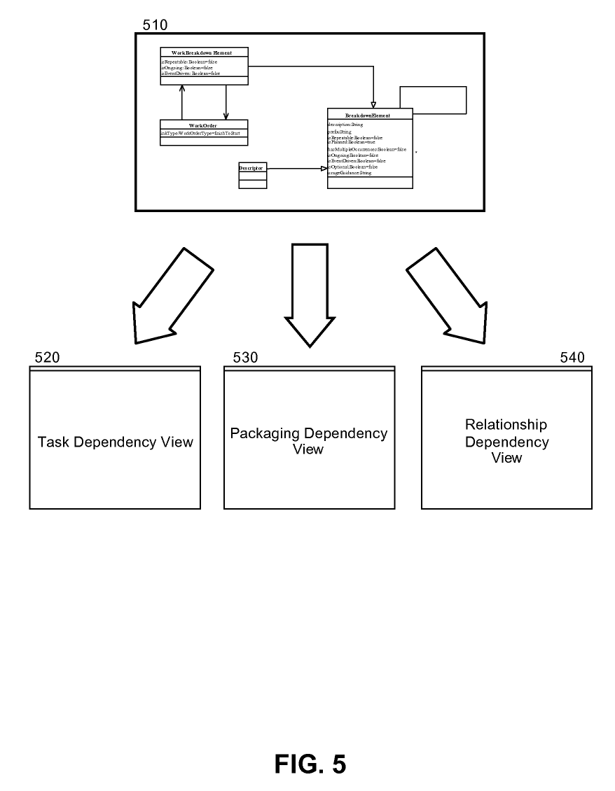

More particularly, as shown in FIG. 5 the process breakdown structure 510 shown uniformly in each of FIG. 2, FIG. 3 and FIG. 4 can supporting the respective views of task dependency 520, packaging dependency 530 and relationship dependency. Changes associated with the process breakdown structure can be reflected immediately in each view 520, 530, 540 without requiring additional modifications to data structures exclusive to any one of the views 520, 530, 540. In particular, the utilization of the descriptor structure further facilitates the support of multiple views from a breakdown structure architecture for a process.

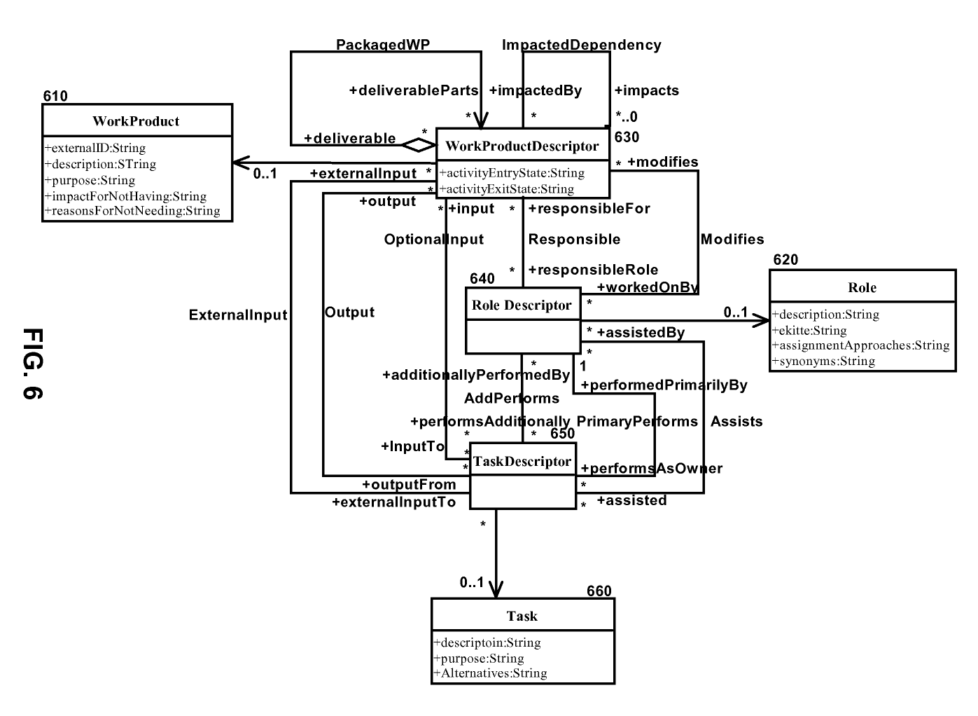

Referring to FIG. 6, a class diagram is shown of reusable method elements as well as breakdown elements of the architecture of FIG. 1 incorporating descriptor linkages. As shown in FIG. 6, a task 660 can be represented in a process by a task descriptor 650 which task 660 can include an aggregation of one or more steps (not shown). Likewise, a role 620 can be represented by a role descriptor 640. Finally, a work product 610 can be represented by a work product descriptor 630. The role descriptor 640 can include associations to task descriptors 650 performed by an associated role 620. Also, the role descriptor 640 can include associations to work product descriptors 630 for which an associated role 620 is responsible. Finally, the work product descriptor 630 and the task descriptor 650 can include associations to indicate input to and output from tasks 660 associated with corresponding task descriptors 650.

In this way, different views of a process can be achieved for the same arrangement of reusable method elements and breakdown elements, irrespective of whether the views are task oriented, work product oriented or role oriented. Moreover, changes in any one of the underlying descriptors for one type of reusable method element automatically translates to linked descriptors for other types of reusable method elements in the arrangement. Accordingly, it is not required to maintain separate data structures to support different corresponding views for a process defined by the arrangement of the reusable method elements.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system configured for providing multiple views for breakdown centric process representations, the system comprising a method management tool comprising program code enabled to render multiple views from a single breakdown structure architecture for a process.

2. The system of claim 1, wherein the multiple views comprises at least two views selected from the group consisting of a work breakdown view, a work product usage view and a team allocation view.

3. The system of claim 1, wherein the single breakdown structure architecture for the process comprises an arrangement of descriptors mirroring default structural relationships of source method elements, each of the descriptors configured to permit changes to the arrangement between the descriptors without changing the default structured relationships of the source method elements.

4. The system of claim 3, wherein each of the source method elements comprises one of a task, a role and a work product.

5. The system of claim 4, wherein each of the descriptors in the arrangement inherits properties from a general breakdown element definition.

6. The system of claim 1, wherein the single breakdown structure architecture for the process comprises a plurality of activities defined for the process wherein each of the activities comprises an aggregation of breakdown elements in a work breakdown structure.

7. A method for providing multiple views for breakdown centric process representations, the method comprising:
defining a single breakdown structure architecture for a process; and,
rendering a plurality of different views for the single breakdown structure architecture for the process.

8. The method of claim 7, wherein defining a single breakdown structure architecture for a process, comprises arranging a plurality of descriptors mirroring default structural relationships of source method elements, each of the descriptors configured to permit changes to the arrangement between the descriptors without changing the default structured relationships of the source method elements.

9. The method of claim 8, wherein defining a single breakdown structure architecture for a process, comprises arranging a plurality of descriptors mirroring default structural relationships of source method elements, the descriptors including one of a task, a role and a work product, each of the descriptors configured to permit changes to the arrangement between the descriptors without changing the default structured relationships of the source method elements.

10. The method of claim 9, further comprising inheriting each of the descriptors in the arrangement from a breakdown element.

11. The method of claim 7, wherein defining a single breakdown structure architecture for a process, comprises:
aggregating breakdown elements in a breakdown structure; and,
defining a plurality activities for the process with the aggregation of breakdown elements in the work breakdown structure.

12. The method of claim 7, wherein rendering a plurality of different views for the single breakdown structure architecture for the process, comprises rendering for the single breakdown structure a plurality of different views selected from the group consisting of a work breakdown view, a work product usage view and a team allocation view.

13. A computer program product comprising a computer usable medium having computer usable program code for providing multiple views for breakdown centric process representations, the computer program product including:
computer usable program code for defining a single breakdown structure architecture for a process; and,
computer usable program code for rendering a plurality of different views for the single breakdown structure architecture for the process.

14. The computer program product of claim 13, wherein the computer usable program code for defining a single breakdown structure architecture for a process, comprises computer usable program code for arranging a plurality of descriptors mirroring default structural relationships of source method elements, each of the descriptors configured to permit changes to the arrangement between the descriptors without changing the default structured relationships of the source method elements.

15. The computer program product of claim 14, wherein the computer usable program code for defining a single breakdown structure architecture for a process, comprises computer usable program code for arranging a plurality of descriptors mirroring default structural relationships of source method elements, the descriptors including one of a task, a role and a work product, each of the descriptors configured to permit changes to the arrangement between the descriptors without changing the default structured relationships of the source method elements.

16. The computer program product of claim 15, further comprising computer usable program code for inheriting each of the descriptors in the arrangement from a breakdown element.

17. The computer program product of claim 13, wherein the computer usable program code for defining a single breakdown structure architecture for a process, comprises:
computer usable program code for aggregating breakdown elements in a work breakdown structure; and,
computer usable program code for defining a plurality activities for the process with the aggregation of breakdown elements in the work breakdown structure.

18. The computer program product of claim 13, wherein the computer usable program code for rendering a plurality of different views for the single breakdown structure architecture for the process, comprises computer usable program code for rendering for the single work breakdown structure a plurality of different views selected from the group consisting of a work breakdown view, a work product usage view and a team allocation view.
